(19) United States
(12) Patent Application Publication
(10) Pub. No.: US 2004/0247943 A1
(43) Pub. Date: Dec. 9, 2004

(54) Perpendicular magnetic recording media with improved fcc Au-containing interlayers

(75) Inventors: Erol Girt, Berkeley, CA (US); Thomas P. Nolan, Mountain View, CA (US)

Correspondence Address: MCDERMOTT, WILL & EMERY, 600 13th Street, N.W., Washington, DC, 20005-3096, US

(73) Assignee: SEAGATE TECHNOLOGY LLC

(21) Appl. No.: 10/776,222

(22) Filed: Feb. 12, 2004

Related U.S. Application Data
(60) Provisional application No. 60/475,833, filed on Jun. 3, 2003.

(51) Int. Cl. G11B 5/72

(52) U.S. Cl. 428/694 T; 428/694 TM

(57) ABSTRACT

A perpendicular magnetic recording medium, comprising a non-magnetic interlayer structure selected from the group consisting of:

(1) a structure comprising a layer of a fcc Au-containing non-magnetic material having a <111> preferred growth orientation and a layer of a different material in overlying or underlying contact therewith;

(2) a structure comprising, in overlying sequence, a layer of a fcc Au-containing non-magnetic material adjacent a magnetically soft underlayer and having a <111> preferred growth orientation; and n layers of a different fcc non-magnetic material having a <111> preferred growth orientation, where n=1-5;

(3) a structure comprising, in overlying sequence, a layer of a fcc Au-containing non-magnetic material adjacent a magnetically soft underlayer and having a <111> preferred growth orientation; and a layer of a hcp non-magnetic material having a <0002> preferred growth orientation;

(4) a structure comprising, in overlying sequence, a layer of a fcc Au-containing non-magnetic material adjacent a magnetically soft underlayer and having a <111> preferred growth orientation; n layers of a different fcc non-magnetic material having a <111> preferred growth orientation, where n=1-5; and n layers of a hcp non-magnetic material having a <0002> preferred growth orientation, where n=1-5; and

(5) an (fcc)₁/(hcp)₁/(fcc)₂/(hcp)₂ structure comprising, in overlying sequence, a first fcc layer (fcc)₁, a first hcp layer (hcp)₁, a second fcc layer (fcc)₂, and a second hcp layer (hcp)₂, wherein at least the first fcc layer is an Au-containing non-magnetic material.

### CROSS REFERENCE TO PROVISIONAL APPLICATION

This application claims priority from U.S. provisional patent application Serial No. 60/475,833 filed Jun. 3, 2003, the entire disclosure of which is incorporated herein by reference.

### FIELD OF THE INVENTION

The present invention relates to high areal recording density perpendicular magnetic recording media comprising improved fcc Au-containing interlayer structures for enhancing formation of main recording layers having optimum crystallographic orientation. The invention is of particular utility in the manufacture of data/information storage and retrieval media, e.g., hard disks, having ultra-high areal recording/storage densities.

### BACKGROUND OF THE INVENTION

Magnetic media are widely used in various applications, particularly in the computer industry, and efforts are continually made with the aim of increasing the areal recording density, i.e., bit density of the magnetic media. In this regard, so-called “perpendicular” recording media have been found to be superior to the more conventional “longitudinal” media in achieving very high bit densities. In perpendicular magnetic recording media, residual magnetization is formed in a direction perpendicular to the surface of the magnetic medium, typically a layer of a magnetic material on a suitable substrate. Very high linear recording densities are obtainable by utilizing a “single-pole” magnetic transducer or “head” with such perpendicular magnetic media.

It is well-known that efficient, high bit density recording utilizing a perpendicular magnetic medium requires interposition of a relatively thick (i.e., as compared to the magnetic recording layer), magnetically “soft” underlayer or “keeper” layer, i.e., a magnetic layer having a relatively low coercivity of about 1 kOe or below, such as of a NiFe alloy (Permalloy), between the non-magnetic substrate, e.g., of glass, aluminum (Al) or an Al-based alloy, and the “hard” magnetic recording layer having relatively high coercivity of several kOe, typically about 3-6 kOe, e.g., of a cobalt-based alloy (e.g., a Co—Cr alloy such as CoCrPtB) having perpendicular anisotropy. The magnetically soft underlayer serves to guide magnetic flux emanating from the head through the hard, perpendicular magnetic recording layer. In addition, the magnetically soft underlayer reduces susceptibility of the medium to thermally-activated magnetization reversal by reducing the demagnetizing fields which lower the energy barrier that maintains the current state of magnetization.

A typical conventional perpendicular recording system 10 utilizing a vertically oriented magnetic medium 1 with a relatively thick soft magnetic underlayer, a relatively thin hard magnetic recording layer, and a single-pole head, is illustrated in FIG. 1, wherein reference numerals 2, 3, 4, and 5, respectively, indicate a non-magnetic substrate, a soft magnetic underlayer, at least one non-magnetic interlayer, and a perpendicular hard magnetic recording layer. Reference numerals 7 and 8, respectively, indicate the single and auxiliary poles of a single-pole magnetic transducer head 6. The relatively thin interlayer 4 (also referred to as an “intermediate” layer), comprised of one or more layers of non-magnetic materials, serves to (1) prevent magnetic interaction between the soft underlayer 3 and the hard recording layer 5 and (2) promote desired microstructural and magnetic properties of the hard recording layer.

As shown by the arrows in the figure indicating the path of the magnetic flux φ, flux φ is seen as emanating from single pole 7 of single-pole magnetic transducer head 6, entering and passing through vertically oriented, hard magnetic recording layer 5 in the region below single pole 7, entering and traveling within soft magnetic underlayer 3 for a distance, and then exiting therefrom and passing through the perpendicular hard magnetic recording layer 5 in the region below auxiliary pole 8 of single-pole magnetic transducer head 6. The direction of movement of perpendicular magnetic medium 1 past transducer head 6 is indicated in the figure by the arrow above medium 1.

With continued reference to FIG. 1, vertical lines 9 indicate grain boundaries of each polycrystalline (i.e., granular) layer of the layer stack constituting medium 1. As is apparent from the figure, the width of the grains (as measured in a horizontal direction) of each of the polycrystalline layers constituting the layer stack of the medium is substantially the same, i.e., each overlying layer replicates the grain width of the underlying layer. A protective overcoat layer 11, such as of a diamond-like carbon (DLC) is formed over hard magnetic layer 5, and a lubricant topcoat layer 12, such as of a perfluoropolyethylene material, is formed over the protective overcoat layer. Substrate 2 is typically disk-shaped and comprised of a non-magnetic metal or alloy, e.g., Al or an Al-based alloy, such as Al—Mg having an Ni—P plating layer on the deposition surface thereof, or substrate 2 is comprised of a suitable glass, ceramic, glass-ceramic, polymeric material, or a composite or laminate of these materials; underlayer 3 is typically comprised of an about 500 to about 4,000 Å thick layer of a soft magnetic material selected from the group consisting of Ni, NiFe (Permalloy), Co, CoZr, CoZrCr, CoZrNb, CoFe, Fe, FeN, FeSiAl, FeSiAlN, FeCoC, FeCoB, etc.; interlayer 4 typically comprises an up to about 300 Å thick layer of a non-magnetic material, such as TiCr; and hard magnetic layer 5 is typically comprised of an about 2 to about 30 nm thick layer of (1) a Co-based alloy including one or more elements selected from the group consisting of Cr, Fe, Ta, Ni, Mo, Pt, V, Nb, Ge, B, and Pd and optionally containing at least one oxide selected from the group consisting of oxides of Si, Ti, Zr, Al, Cr, Co, Nb, Mg, and Zn; (2) iron nitrides; or (3) a (CoX/Pd or Pt)ₙ multilayer magnetic superlattice structure, where n is an integer from about 10 to about 25, each of the alternating, thin layers of Co-based magnetic alloy is from about 0.2 to about 0.6 mn thick, X is an element selected from the group consisting of Cr, Ta, B, Mo, Pt, W, and Fe, and each of the alternating thin, non-magnetic layers of Pd or Pt is about 0.6 to about 1.2 nm thick. Each type of hard magnetic recording layer material has perpendicular anisotropy arising from magneto-crystalline anisotropy (1^{st} type) and/or interfacial anisotropy (2^{nd} type).

Notwithstanding the improvement (i.e., increase) in areal recording density and SMNR afforded by perpendicular magnetic recording media as described supra, the escalating requirements for increased areal recording density, media stability and SMNR necessitate further improvement in media performance.

As indicated above, perpendicular magnetic recording media typically include a magnetically soft underlayer for guiding magnetic flux through the media and to enhance writability, a thin intermediate or interlayer, and a main recording layer. The role of the intermediate or interlayer is critical for obtaining good media performance. Specifically, in perpendicular magnetic recording media the intermediate or interlayer serves to provide:

1. control of the crystallographic orientation of the main recording layer;

2. control of the grain size and grain distribution of the main recording layer; and

3. physical separation between adjacent grains of the main recording layer, which feature is particularly desirable and important when the latter is formed by a low temperature and/or reactive sputtering process, so that growth of oxides occurs in the boundaries between adjacent grains.

In view of the foregoing critical nature of the intermediate or interlayer in perpendicular magnetic recording media, there exists a clear need for improved perpendicular magnetic recording media comprising improved intermediate or interlayer structures for providing enhanced performance.

The present invention, therefore, addresses and solves problems attendant upon the design and manufacture of improved performance ultra-high areal recording density perpendicular magnetic recording media, while maintaining full compatibility with the economic requirements of cost-effective, large-scale automated manufacturing technology.

### DISCLOSURE OF THE INVENTION

An advantage of the present invention is an improved high areal recording density perpendicular magnetic recording medium.

This and additional advantages and other features of the present invention will be set forth in the description which follows and in part will become apparent to those having ordinary skill in the art upon examination of the following or may be learned from the practice of the present invention. The advantages of the present invention may be realized as particularly pointed out in the appended claims.

According to an aspect of the present invention, the foregoing and other advantages are obtained in part by a perpendicular magnetic recording medium, comprising:

(a) a non-magnetic substrate having a surface; and

(b) a layer stack formed over the substrate surface, the layer stack comprising, in overlying sequence from the substrate surface:

(i) a magnetically soft underlayer;

(ii) a non-magnetic interlayer structure; and

(iii) a magnetically hard perpendicular main recording layer;

wherein the non-magnetic interlayer is selected from the group consisting of:

(1) a structure comprising a layer of a fcc Au-containing non-magnetic material having a <111> preferred growth orientation and a layer of a different material in overlying or underlying contact with the layer of fcc Au-containing non-magnetic material;

(2) a structure comprising, in overlying sequence, a layer of a fcc Au-containing non-magnetic material adjacent the magnetically soft underlayer and having a <111> preferred growth orientation; and n layers of a different fcc non-magnetic material having a <111> preferred growth orientation, where n=1-5;

(3) a structure comprising, in overlying sequence, a layer of a fcc Au-containing non-magnetic material adjacent the magnetically soft underlayer and having a <111> preferred growth orientation; and a layer of a hcp non-magnetic material having a <0002> preferred growth orientation;

(4) a structure comprising, in overlying sequence, a layer of a fcc Au-containing non-magnetic material adjacent the magnetically soft underlayer and having a <111> preferred growth orientation; n layers of a different fcc non-magnetic material having a <111> preferred growth orientation, where n=1-5; and n layers of a hcp non-magnetic material having a <0002> preferred growth orientation, where n=1-5; and

(5) an (fcc)₁/(hcp)₁/(fcC)₂/(hcp)₂ structure comprising, in overlying sequence, a first fcc layer (fcc)₁, a first hcp layer (hcp)₁, a second fcc layer (fcc)₂, and a second hcp layer (hcp)₂, wherein at least the first fcc layer is an Au-containing non-magnetic material.

According to embodiments of the present invention, the non-magnetic interlayer structure is about 0.2 to about 50 nm thick, preferably about 0.25 to about 25 nm thick; the layer of a fcc Au-containing material having a <111> preferred growth orientation is about 0.2 to about 20 nm thick, preferably about 0.5 to about 10 nm thick, and comprises Au with at least one element added thereto, selected from the group consisting of Al, Ag, Cr, Cu, Ga, Hf, In, Ir, Mn, Nb, Pd, Pt, Sc, Sn, Ta, Ti, V, Zn, Zr, Mo, and W; the n layers of a different fcc non-magnetic material having a <111> preferred growth orientation have a total thickness from about 0.2 to about 20 nm, preferably about 0.5 to about 10 nm, and are each comprised of an element selected from the group consisting of Rh, Ir, Pd, Pt, Cu, Ag, Al, Au, and their alloys; the n layers of a different fcc non-magnetic material having a <111> preferred growth orientation contain minor amounts of bcc-structured elements selected from the group consisting of W, Mo, Ta, Nb, Cr, and V; the n layers of a hcp non-magnetic material having a <0002> preferred growth orientation have a total thickness from about 0.2 to about 40 mn, preferably about 1 to about 20 nm, and are each comprised of an element selected from the group consisting of Ru, Re, Hf, Ti, and Zr, and contain minor amounts of at least one bcc-structured element selected from the group consisting of W, Mo, Ta, Nb, Cr, and V; the magnetically soft underlayer is about 10 to about 1,000 nm thick, preferably about 40 to about 200 nm thick, and comprised of Fe containing at least one element selected from the group consisting of Co, B, P, Si, C, N, Zr, Nb, Hf, Ta, Al, Cu, Ag, and Au; the magnetically hard perpendicular recording layer is about 2 to about 30 nm thick, preferably about 4 to about 15 nm thick, and includes at least one layer of a ferromagnetic material selected from the group consisting of: (1) Co alloys containing at least one element selected from the group consisting of Pt, Cr, Ta, B, Cu, W, Mo, and Nb, with or without at least one oxide selected from the group consisting of Si, Ti, Zr, Al, Ct, Co, Nb, Mg, and Zn; (2) iron nitrides; and (3) (CoX/Pd or Pt)ₙ multilayer magnetic superlattice structures, where n is an integer from about 10 to about 25, each of the alternating, thin layers of Co-based magnetic alloy is from about 0.2 to about 0.6 nm thick, X is an element selected from the group consisting of Cr, Ta, B, Mo, Pt, W, and Fe, and each of the alternating thin, non-magnetic layers of Pd or Pt is about 0.6 to about 1.2 nm thick; the non-magnetic substrate comprises a material selected from the group consisting of Al, NiP-plated Al, Al—Mg alloys, other Al-based alloys, other non-magnetic metals, other non-magnetic alloys, glass, ceramics, polymers, glass-ceramics, and composites and/or laminates thereof, and may further include an adhesion layer on the surface thereof, comprised of a material selected from the group consisting of Cr, CrTi, Ti, and TiNb.

An amorphous layer (iv) up to about 10 nm thick, preferably 0.2 to about 2 nm thick, and comprised of a material selected from TiCr, TaCr, NiTa, NiNb, NiP, CrZr, and CoW may be present between the magnetically soft underlayer (i) and the non-magnetic interlayer (ii) when the former is not amorphous. Amorphous layer (iv) may also contain at least one oxide selected from the group consisting of oxides Si, Ti, Zr, Al, Cr, Co, Nb, Mg, and Zn.

Embodiments of media according to the present invention further comprise:

(c) a protective overcoat layer on the main recording layer; and

(d) a lubricant topcoat layer on the protective overcoat layer.

Additional advantages and aspects of the present invention will become readily apparent to those skilled in the art from the following detailed description, wherein embodiments of the present invention are shown and described, simply by way of illustration of the best mode contemplated for practicing the present invention. As will be described, the present invention is capable of other and different embodiments, and its several details are susceptible of modification in various obvious respects, all without departing from the spirit of the present invention. Accordingly, the drawings and description are to be regarded as illustrative in nature, and not as limitative.

### BRIEF DESCRIPTION OF THE DRAWINGS

The following detailed description of the embodiments of the present invention can best be understood when read in conjunction with the following drawings, in which the various features are not necessarily drawn to scale but rather are drawn as to best illustrate the pertinent features, and in which like reference numerals are employed throughout to designate similar features, wherein:

FIG. 1 schematically illustrates, in simplified cross-sectional view, a portion of a magnetic recording, storage, and retrieval system comprised of a single-pole transducer head and a conventional perpendicular type magnetic recording medium including soft magnetic, non-magnetic intermediate, a hard perpendicular recording layers; and

FIG. 2 schematically illustrates, in simplified cross-sectional view, a portion of a perpendicular magnetic recording medium including an improved non-magnetic interlayer structure according to the invention.

### DESCRIPTION OF THE INVENTION

The present invention is based upon recognition by the inventors that very high areal recording density perpendicular magnetic recording media which utilize magnetic alloys as the material of the main recording layer, e.g., CoCr-based alloys, can be reliably and controllably fabricated with optimum crystallographic properties (e.g., orientation), grain size, and separation of adjacent grains of the main recording layer, by appropriate design and selection of materials of a non-magnetic interlayer structure positioned between the magnetically soft underlayer and the magnetically hard main recording layer.

A feature, therefore, of the present invention, is selection of materials and arrangement of a plurality of stacked layers of different materials for forming improved intermediate layer structures which provide:

1. improved control of the crystallographic orientation of the main recording layer;

2. improved control of the grain size and grain distribution of the main recording layer; and

3. improved physical separation between adjacent grains of the main recording layer, which feature is particularly desirable and important when the latter is formed by a low temperature and/or reactive sputtering process, so that growth of oxides occurs in the boundaries between adjacent grains.

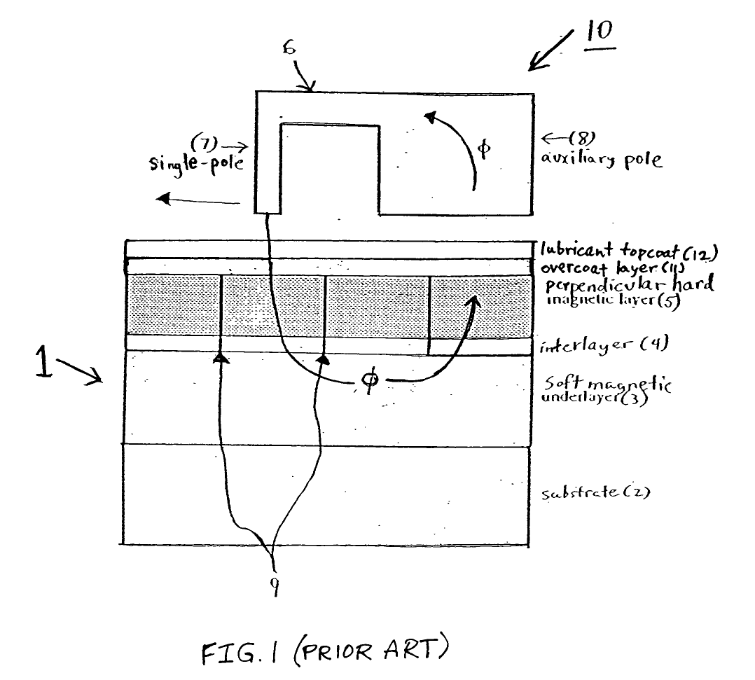

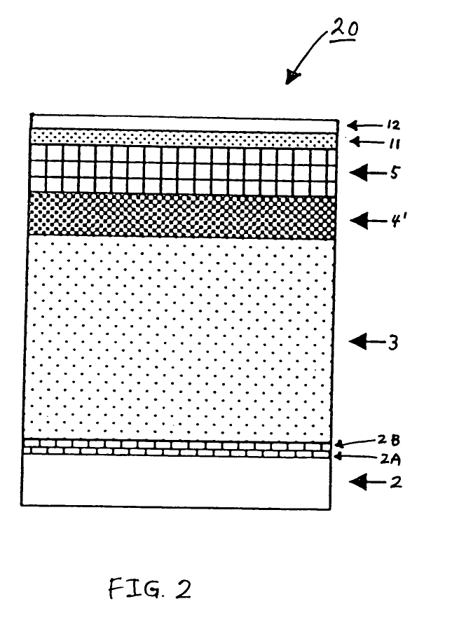

Referring now to FIG. 2, schematically illustrated therein, in simplified perspective view, is a portion of a perpendicular magnetic recording medium 20 fabricated according to the principles of the present invention. More specifically, perpendicular magnetic recording medium 20 resembles the conventional perpendicular magnetic recording medium 1 of FIG. 1, and comprises a series of thin-film layers arranged in an overlying (stacked) sequence on a suitable non-magnetic substrate 2, and includes a soft magnetic underlayer 3, a non-magnetic interlayer structure 4′ according to the present invention, a perpendicularly oriented, magnetically hard (main) recording layer 5, a protective overcoat layer 11, and a lubricant topcoat layer 12.

In accordance with embodiments of the present invention, e.g., as with hard disks, the non-magnetic substrate 2 is sufficiently thick as to provide medium 20 with a desired rigidity and comprises a material selected from the group consisting of Al, NiP-plated Al, Al—Mg alloys, other Al-based alloys, other non-magnetic metals, other non-magnetic alloys, glass, ceramics, polymers, glass-ceramics, and composites and/or laminates thereof. Substrate 2 may further comprise, in overlying sequence on the surface thereof, a plating layer 2A and an adhesion layer 2B. A suitable material for plating layer 2A, as when substrate 2 is composed of Al or an Al alloy such as Al—Mg, is amorphous NiP, and suitable materials for adhesion layer 2B include Cr, CrTi, Ti, TiNb, and CoW.

Overlying substrate 2 is a magnetically soft underlayer 3, about 10 to about 400 nm thick, preferably about 40 to about 1,000 nm thick, comprised of Fe containing at least one element selected from the group consisting of Co, B, P, Si, C, N, Zr, Nb, Hf, Ta, Al, Cu, Ag, and Au.

Non-magnetic interlayer structure 4′ according to the present invention is interposed between the magnetically soft underlayer 3 and the magnetically hard (main) perpendicular recording layer 5 and is described in detail below.

Magnetically hard perpendicular recording layer 5 is about 2 to about 30 nm thick, preferably about 4 to about 15 nm thick, and includes at least one layer of a ferromagnetic material selected from the group consisting of: (1) Co alloys containing at least one element selected from the group consisting of Pt, Cr, Ta, B, Cu, W, Mo, and Nb with or without at least one oxide selected from the group consisting of Si, Ti, Zr, Al, Ct, Co, Nb, Mg, and Zn; (2) iron nitrides; and (3) (CoX/Pd or Pt)ₙ multilayer magnetic superlattice structures, where n is an integer from about 10 to about 25, each of the alternating, thin layers of Co-based magnetic alloy is from about 0.2 to about 0.6 nm thick, X is an element selected from the group consisting of Cr, Ta, B, Mo, Pt, W, and Fe, and each of the alternating thin, non-magnetic layers of Pd or Pt is about 0.6 to about 1.2 nm thick

Completing the layer stack of medium 20 are protective overcoat layer 11 atop recording layer 5, typically a layer of a carbon-containing material <10 nm thick, and a lubricant topcoat layer 12 atop the protective overcoat layer 11, typically a layer of a perfluoropolyether <5 nm thick.

According to the present invention, non-magnetic interlayer 4′ is selected from the group consisting of:

(1) a structure comprising a layer of a fcc Au-containing non-magnetic material having a <111> preferred growth orientation and a layer of a different material in overlying or underlying contact with the layer of fcc Au-containing non-magnetic material;

(2) a structure comprising, in overlying sequence, a layer of a fcc Au-containing non-magnetic material adjacent the magnetically soft underlayer 3 and having a <111> preferred growth orientation; and n layers of a different fcc non-magnetic material having a <111> preferred growth orientation, where n=1-5;

(3) a structure comprising, in overlying sequence, a layer of a fcc Au-containing non-magnetic material adjacent the magnetically soft underlayer 3 and having a <111> preferred growth orientation; and a layer of a hcp non-magnetic material having a <0002> preferred growth orientation;

(4) a structure comprising, in overlying sequence, a layer of a fcc Au-containing non-magnetic material adjacent the magnetically soft underlayer 3 and having a <111> preferred growth orientation; n layers of a different fcc non-magnetic material having a <111> preferred growth orientation, where n=1-5; and n layers of a hcp non-magnetic material having a <0002> preferred growth orientation, where n=1-5; and

(5) an (fcc)₁/(hcp)₁/(fcc)₂/(hcp)₂ structure comprising, in overlying sequence, a first fcc layer (fcc)₁, a first hcp layer (hcp)₁, a second fcc layer (fcc)₂, and a second hcp layer (hcp)₂, wherein at least the first fcc layer is an Au-containing non-magnetic material.

According to embodiments of the present invention, the non-magnetic interlayer structure 4′ is about 0.2 to about 50 nm thick, preferably about 0.25 to about 25 nm thick; and:

(1) the layer of a fcc Au-containing material having a <111> preferred growth orientation is about 0.2 to about 20 nm thick, preferably about 1 to about 10 nm thick, and comprises Au with at least one element added thereto, selected from the group consisting of Al, Ag, Cr, Cu, Ga, Hf, In, Ir, Mn, Nb, Pd, Pt, Sc, Sn, Ta, Ti, V, Zn, Zr, Mo, and W;

(2) the n layers of a different fcc non-magnetic material having a <111> preferred growth orientation have a total thickness from about 0.2 to about 20 nm, preferably about 0.5 to about 10 nm, and are each comprised of an element selected from the group consisting of Rh, Ir, Pd, Pt, Cu, Ag, Al, Au, and their alloys; and they may contain minor amounts of bcc-structured elements selected from the group consisting of W, Mo, Ta, Nb, Cr, and V; and

(3) the n layers of a hcp non-magnetic material having a <0002> preferred growth orientation have a total thickness from about 0.2 to about 40 nm, preferably about 0.5 to about 20 nm, and are each comprised of an element selected from the group consisting of Ru, Re, Hf, Ti, and Zr.

An amorphous layer up to about 10 nm thick, preferably about 0.2 to about 2 nm thick, and comprised of a material selected from TiCr, TaCr, NiTa, NiNb, NiP, CrZr, and CoW, e.g., TiₓCr₁₀₀₋ₓ and TaₓCr₁₀₀₋ₓ, where 30<x<60, may be located between the magnetically soft underlayer and the non-magnetic interlayer structure when the former is not amorphous. The amorphous layer may also contain at least one oxide selected from the group consisting of oxides Si, Ti, Zr, Al, Cr, Co, Nb, Mg, and Zn.

Each of the thin film layers 2A, 2B, 3, the component layers of intermediate layer 4′, and 5 and the protective overcoat layer 11 may be formed by utilizing at least one physical vapor deposition (PVD) method selected from sputtering, reactive sputtering, vacuum evaporation, ion plating, ion beam deposition (IBD), and plasma deposition, or at least one chemical vapor deposition method selected from CVD, MOCVD, and PECVD; and lubricant topcoat layer 12 may be formed by utilizing at least one method selected from dipping, spraying, and vapor deposition.

Reactive sputtering of the magnetically hard perpendicular recording layer 5 in an Ar/O₂ atmosphere is preferred for enabling formation of an intergranular Co oxide when layer 5 is comprised of a Co-based magnetic alloy. The target utilized for sputtering the magnetically hard recording layer may comprise Co with one or more added elements, selected from the group consisting of Pt, Cr, Ta, B, Cu, W, Mo, and Nb. The magnetic recording layer and the interlayer structures according to the invention may be formed at low temperatures, e.g., <˜400° K., or grown at higher temperatures, generally >˜420° K. and <˜600° K.

According to the present invention, the compositions (i.e., materials), and thicknesses of the component layers of the non-magnetic interlayer structure 4′ and the magnetic alloy-based, perpendicular hard magnetic recording layer 5 are selected as to act in concert to provide medium 20 with improved performance characteristics vis-à-vis medium 1.

### EXAMPLE

A series of partial media structures (i.e., without a magnetic recording layer 5) according to the present invention, comprised of substrate 2/adhesion layer 2B/amorphous magnetically soft underlayer 3 (of FeCoB)/interlayer structure 4′ were fabricated by magnetron co-sputtering of up to four different targets at a base pressure of ˜1×10⁻⁸ Torr and an Ar pressure of 5 mTorr, wherein the interlayer structure 4′ of X (1.5 nm)/Ru (10 nm) corresponds to structure (3) described supra, and X=Ag, Al, Au, Cu, Ir, Re, Ru, Ti, ITO, CoCr, and CoCrPt.

Rocking curves of each partial structure were measured at the full width at half maximum (FWHM) of the rocking curve in order to determine the degree of [0002] crystal orientation. Table I below summarizes the results of the rocking curve measurement of FWHM and includes the lattice constants of each of the possible materials for layer X. In the Table, a_{ca} represents the distance of closest approach in a fcc structure, and is to be compared with the lattice constant a of hcp Ru and Re in order to understand the effect of lattice mismatch between fcc layers (e.g., when X=Al, Ag, Au, Cu, Ir) that grow predominantly with <111> orientation on top of the magnetically soft underlayer 3 and hcp layers (e.g., Ru and Re) that grow predominantly with <0002> orientation. It follows from the data of Table I that:

1. the best <0002> orientation of the Ru interlayer is achieved by placing an fcc Au-containing interlayer in contact with the magnetically soft underlayer 3 and below the Ru interlayer;

2. Ag, Au, Cu, Re, their alloys, and CoCrPt improve the <0002> orientation of the Ru interlayer; and

3. reduced lattice mismatch may be significant for improving the degree of <0002> orientation; see, e.g., X=CoCr and CoCrPt.

TABLE I

| X | Ag | Al | Au | Cu | Ir | Re | Ru | Ti | ITO | CoCr | CoCrPt |
|---|---|---|---|---|---|---|---|---|---|---|---|
| a[nm] | .408 | .405 | .409 | .361 | .384 | .276 | .271 | .295 | | .251 | .263 |
| c[nm] | | | | | | .446 | .428 | .468 | | .407 | .427 |
| a_{ca}[nm] | .288 | .286 | .288 | .255 | .271 | | | | | | |
| FWHM | 4.1 | <15 | 3.47 | 4.27 | 7.48 | 4.81 | 5.43 | 5.42 | <15 | 5.39 | 4.38 |
| (deg.) | | | | | | | | | | | |

In view of the foregoing, it is evident that formation of improved interlayer structures for perpendicular magnetic recording media, comprising a fcc Au-containing interlayer, can result in improved mismatch with an overlying hcp interlayer and improved microstructure of the hcp interlayer. According to the invention, elements which are soluble in Au can be added thereto, and include Al, Ag, Cr, Cu, Ga, Hf, In, Ir, Mn, Nb, Pd, Pt, Sc, Sn, Ta, Ti, V, Zn, and Zr. In addition, small amounts of Mo and W can be added to the Au-containing layer.

Thus, the present invention advantageously provides improved, high areal density, magnetic alloy-based perpendicular magnetic data/information and storage retrieval media including an improved non-magnetic interlayer which provides advantageous crystal lattice matching and orientation of the magnetic recording layer which afford improved media performance characteristics. The media of the present invention are especially useful when employed in conjunction with single-pole recording/retrieval transducer heads and enjoy particular utility in high recording density systems for computer-related applications. In addition, the inventive media can be fabricated by means of conventional media manufacturing technologies, e.g., sputtering.

In the previous description, numerous specific details are set forth, such as specific materials, structures, processes, etc., in order to provide a better understanding of the present invention. However, the present invention can be practiced without resorting to the details specifically set forth. In other instances, well-known processing materials and techniques have not been described in detail in order not to unnecessarily obscure the present invention.

Only the preferred embodiments of the present invention and but a few examples of its versatility are shown and described in the present disclosure. It is to be understood that the present invention is capable of use in various other combinations and environments and is susceptible of changes and/or modifications within the scope of the inventive concept as expressed herein.

What is claimed is:

1. A perpendicular magnetic recording medium, comprising:
(a) a non-magnetic substrate having a surface; and
(b) a layer stack formed over said substrate surface, said layer stack comprising, in overlying sequence from said substrate surface:
(i) a magnetically soft underlayer;
(ii) a non-magnetic interlayer structure; and
(iii) a magnetically hard perpendicular main recording layer;
wherein said non-magnetic interlayer structure is selected from the group consisting of:
(1) a structure comprising a layer of a fcc Au-containing non-magnetic material having a <111> preferred growth orientation and a layer of a different material in overlying or underlying contact with said layer of fcc Au-containing non-magnetic material;
(2) a structure comprising, in overlying sequence, a layer of a fcc Au-containing non-magnetic material adjacent said magnetically soft underlayer and having a <111> preferred growth orientation; and n layers of a different fcc non-magnetic material having a <111> preferred growth orientation, where n=1-5;
(3) a structure comprising, in overlying sequence, a layer of a fcc Au-containing non-magnetic material adjacent said magnetically soft underlayer and having a <111> preferred growth orientation; and a layer of a hcp non-magnetic material having a <0002> preferred growth orientation;
(4) a structure comprising, in overlying sequence, a layer of a fcc Au-containing non-magnetic material adjacent said magnetically soft underlayer and having a <111> preferred growth orientation; n layers of a different fcc non-magnetic material having a <111> preferred growth orientation, where n=1-5; and n layers of a hcp non-magnetic material having a <0002> preferred growth orientation, where n=1-5; and
(5) an (fcc)₁/(hcp)₁/(fcc)₂/(hcp)₂ structure comprising, in overlying sequence, a first fcc layer (fcc)₁, a first hcp layer (hcp)₁, a second fcc layer (fcc)₂, and a second hcp layer (hcp)₂, wherein at least the first fcc layer is an Au-containing non-magnetic material.

2. The medium as in claim 1, wherein:
said non-magnetic interlayer structure is about 0.2 to about 50 nm thick.

3. The medium as in claim 2, wherein:
said non-magnetic interlayer structure is about 0.25 to about 25 nm thick.

4. The medium as in claim 1, wherein:
said layer of a fcc Au-containing material having a <111> preferred growth orientation is about 0.2 to about 20 nm thick and comprises Au with at least one element added thereto, selected from the group consisting of Al, Ag, Cr, Cu, Ga, Hf, In, Ir, Mn, Nb, Pd, Pt, Sc, Sn, Ta, Ti, V, Zn, Zr, Mo, and W.

5. The medium as in claim 4, wherein:
said layer of a fcc Au-containing material having a <111> preferred growth orientation is about 0.5 to about 10 nm thick.

6. The medium as in claim 1, wherein:
said n layers of a different fcc non-magnetic material having a <111> preferred growth orientation have a total thickness from about 0.2 to about 20 nm and are each comprised of an element selected from the group consisting of Rh, Ir, Pd, Pt, Cu, Ag, Al, Au, and their alloys.

7. The medium as in claim 6, wherein:
said n layers of a different fcc non-magnetic material having a <111> preferred growth orientation have a total thickness from about 0.5 to about 10 nm.

8. The medium as in claim 6, wherein:
said n layers of a different fcc non-magnetic material having a <111> preferred growth orientation contain minor amounts of bcc-structured elements selected from the group consisting of W, Mo, Ta, Nb, Cr, and V.

9. The medium as in claim 1, wherein:
said n layers of a hcp non-magnetic material having a <0002> preferred growth orientation have a total thickness from about 0.2 to about 40 nm, are each comprised of an element selected from the group consisting of Ru, Re, Hf, Ti, and Zr, and contain minor amounts of at least one bcc-structured element selected from the group consisting of W, Mo, Ta, Nb, Cr, and V.

10. The medium as in claim 9, wherein:
said n layers of a hcp non-magnetic material having a <0002> preferred growth orientation have a total thickness from about 0.5 to about 20 nm.

11. The medium as in claim 1, wherein:
said magnetically soft underlayer is about 10 to about 1,000 nm thick and comprised of Fe containing at least one element selected from the group consisting of Co, B, P, Si, C, N, Zr, Nb, Hf, Ta, Al, Cu, Ag, and Au.

12. The medium as in claim 11, wherein:
said magnetically soft underlayer is about 40 to about 200 nm thick.

13. The medium as in claim 1, wherein:
said magnetically hard perpendicular recording layer is about 2 to about 30 nm thick and includes at least one layer of a ferromagnetic material selected from the group consisting of: (1) Co alloys containing at least one element selected from the group consisting of Pt, Cr, Ta, B, Cu, W, Mo, and Nb, with or without at least one oxide selected from the group consisting of oxides of Si, Ti, Zr, Al, Cr, Co, Nb, Mg, and Zn; (2) iron nitrides; and (3) (CoX/Pd or Pt)ₙ multilayer superlattice structures, where n is an integer from about 10 to about 25, each of the alternating, thin layers of Co-based magnetic alloy is from about 0.2 to about 0.6 nm thick, X is an element selected from the group consisting of Cr, Ta, B, Mo, Pt, W, and Fe, and each of the alternating thin, non-magnetic layers of Pd or Pt is about 0.6 to about 1.2 nm thick.

14. The medium as in claim 13, wherein:
said magnetically hard perpendicular recording layer is about 4 to about 15 nm thick.

15. The medium as in claim 1, further comprising:
(iv) an amorphous layer up to about 10 nm thick located between said magnetically soft underlayer (i) and said non-magnetic interlayer structure (ii) when said magnetically soft underlayer (i) is not amorphous, and comprised of a material selected from TiCr, TaCr, NiTa, NiNb, NiP, CrZr, and CoW, with or without at least one oxide selected from the group consisting of oxides of Si, Ti, Zr, Al, Cr, Co, Nb, Mg, and Zn.

16. The medium as in claim 15, wherein:
said amorphous layer is about 0.2 to about 2 nm thick.

17. The medium as in claim 1, wherein:
said non-magnetic substrate (a) comprises a material selected from the group consisting of Al, NiP-plated Al, Al—Mg alloys, other Al-based alloys, other non-magnetic metals, other non-magnetic alloys, glass, ceramics, polymers, glass-ceramics, and composites and/or laminates thereof.

18. The medium as in claim 17, wherein:
said non-magnetic substrate includes an adhesion layer on said surface.

19. The medium as in claim 18, wherein:
said adhesion layer is comprised of a material selected from the group consisting of Cr, CrTi, Ti, and TiNb.

20. The medium as in claim 1, further comprising:
(c) a protective overcoat layer on said main recording layer; and
(d) a lubricant topcoat layer on said protective overcoat layer.
